(19) United States
(12) Patent Application Publication
(10) Pub. No.: US 2023/0170552 A1
(43) Pub. Date: Jun. 1, 2023

(54) BATTERY ARRANGEMENT, MOTOR VEHICLE AND METHOD FOR FLOODING A HIGH-VOLTAGE BATTERY

(71) Applicant: AUDI AG, Ingolstadt (DE)

(72) Inventors: Dirk BAEDER, Fellbach (DE); Michael GRABOWSKI, Ingolstadt (DE)

(73) Assignee: AUDI AG, Ingolstadt (DE)

(21) Appl. No.: 17/922,653

(22) PCT Filed: Jul. 16, 2021
(86) PCT No.: PCT/EP2021/069964

§ 371 Date: Nov. 1, 2022

(30) Foreign Application Priority Data
Jul. 16, 2020 (DE) 10 2020 118 892.7
Nov. 24, 2020 (DE) 10 2020 131 108.7

(51) Int. Cl. H01M 10/6568; H01M 10/625; B60L 50/64; B60K 1/04

(52) U.S. Cl. CPC H01M 10/6568; H01M 10/625; B60L 50/64; B60K 1/04; H01M 2220/20; B60K 2001/0438; B60K 2001/005

(57) ABSTRACT

A battery arrangement for a motor vehicle, the battery arrangement has a high voltage battery which has a battery housing and several battery cells in the battery housing, and a flooding device for flooding the high voltage battery. The flooding device has at least one supply connection, and the battery arrangement is formed to introduce a cooling medium supplied to the at least one supply connection into the battery housing. Furthermore, the flooding device includes at least one drain through which cooling medium supplied to the battery housing can be guided out of the battery arrangement.

### FIELD

The invention relates to a battery arrangement for a motor vehicle, wherein the battery arrangement has a high voltage battery which has a battery housing and several battery cells in the battery housing. Furthermore, the battery arrangement comprises a flooding device for flooding the high voltage battery, wherein the flooding device has at least one supply connection and wherein the battery arrangement is formed to introduce a cooling medium supplied to at least one supply connection into a battery housing. A motor vehicle with such a battery arrangement and a method for flooding a high voltage battery are also part of the invention.

### BACKGROUND

After a vehicle accident of a battery-powered motor vehicle, in particular if the high voltage battery is damaged and/or on fire, it is intended for safety reasons to place the entire vehicle in a container and to flood the vehicle in the container with water. In doing so, the car is completely flooded. This requires a container, a fire fighting vehicle to fill the container with water and a crane to lift the vehicle into the container filled with water. Furthermore, it is also known from the prior art to also flood the battery housing directly. This can be realized by the fire brigade with a so-called extinguishing lance. Here, an extinguishing lance is shot through the vehicle floor into the battery and the latter is flooded. However, the fire brigade has to be specially trained for this, and mistakes still often happen today. In addition, the extinguishing lance cannot be shot into the battery if the doors cannot be opened after a crash. In addition, every fire brigade must then be equipped with such an extinguishing lance, which represents expensive special equipment.

Furthermore, other extinguishing possibilities are also known from the prior art. For example, DE 10 2014 011 609 A1 describes a motor vehicle with a high voltage battery and at least one functional opening set up for the passage of air during normal operation of the motor vehicle. Furthermore, the motor vehicle has a fluid connection from the functional opening to the high voltage battery in order to conduct an extinguishing liquid from the functional opening to the high voltage battery in an extinguishing operation. There is no need for an increased extinguishing water pressure generated by a fire brigade pump, but it can be sufficient to pour water onto the functional opening manually, for example by means of a bucket. Furthermore, the fluid connection can be formed by a fluid line, such as a pipe connection. The fluid connection can also open into a housing for the high voltage battery.

Furthermore, DE 10 2018 125 103 A1 describes a vehicle with a high voltage storage that has a housing in which several storage cells are arranged. Furthermore, the vehicle has an extinguishing access via which a fire extinguishing agent can be supplied in the event of a fire, namely to the high voltage storage housing or into the interior of the high voltage storage housing. Provision is made here for extinguishing agent to be conducted or sprayed from the extinguishing access to an upper outside of the high voltage storage housing. Furthermore, an extinguishing coupling can be provided, to which an extinguishing agent hose, for example from the fire brigade, can be connected directly, which can also be covered by a cover element.

Furthermore, DE 10 2013 021 416 A1 describes a high voltage battery, in particular for a motor vehicle, with a housing that is hermetically sealed to the outside for accommodating galvanic cells, wherein the housing has an interface for connecting an extinguishing device through which extinguishing agents can be introduced into the housing of the high voltage battery. The interface can have an extinguishing agent connection.

Nevertheless, there is a need for further optimization with regard to cooling or extinguishing an overheated or burning high voltage battery.

### SUMMARY

It is therefore the object of the present invention to provide a battery arrangement, a motor vehicle and a method for flooding a high voltage battery which enable the most efficient possible cooling or extinguishing of an overheated or burning high voltage battery.

A battery arrangement according to the invention for a motor vehicle has a high voltage battery which comprises a battery housing and several battery cells arranged in the battery housing. Furthermore, the battery arrangement comprises a flooding device for flooding the high voltage battery, wherein the flooding device has at least one supply connection and wherein the battery arrangement is formed to introduce a cooling medium supplied to the at least one supply connection into the battery housing. Furthermore, the flooding device preferably has at least one drain means through which cooling medium supplied to the battery housing can be discharged from the battery arrangement.

This is particularly advantageous because the invention is based on the finding that the cooling effect can be increased enormously, on the one hand by not only being able to fill the battery housing with a cooling medium, but can also be flowed through by providing a corresponding drain means, shortly also referred to as drain below, and on the other hand, that thereby defined flow conditions can be adjusted, whereby the cooling medium throughput can be increased and thereby the effectiveness of the cooling can be maximized. By flowing through the battery housing, significantly more thermal energy can be released from the battery to the cooling medium per unit of time. The drain allows the warm cooling medium to be discharged, while at the same time new and cold cooling medium can be supplied via the supply connection.

According to a configuration of the invention, the flooding device comprises a housing structure which encloses the high voltage battery so that a through-flowable intermediate space which surrounds the battery housing on all sides remains, and wherein the flooding device is formed to supply a cooling medium supplied to the at least one supply connection to the intermediate space. Such a housing structure can also be provided independently of the provision of the drain means. In other words, according to a second aspect, the invention relates to a battery arrangement for a motor vehicle, with a high voltage battery which comprises a battery housing and several battery cells arranged in the battery housing, wherein the battery arrangement comprises a flooding device for flooding the high voltage battery, wherein the flooding device has at least one supply connection, and wherein the battery arrangement is formed to introduce a cooling medium supplied to the at least one supply connection into the battery housing, wherein the flooding device has a housing structure which encloses the high voltage battery so that a through-flowable intermediate space which surrounds the battery housing on all sides remains, and wherein the flooding device is formed to supply a cooling medium supplied to the at least one supply connection to the intermediate space.

This configuration or the invention according to the second aspect is based on several findings at the same time: On the one hand, a significantly greater cooling effect can be achieved if the high voltage battery can be cooled not only primarily on one side, but on all sides, which is accomplished with the through-flowable intermediate space which surrounds the high voltage battery on all sides which is formed between the battery housing of the high voltage battery and the housing structure. The housing structure, which encloses the high voltage battery, also allows the supplied cooling medium to be kept in the immediate vicinity of the high voltage battery, in particular in contrast to variants in which extinguishing agent is supplied to the battery so that it hits a top of the battery, for example, and then runs down the sides or something similar. With the housing structure, a coolant and extinguishing agent tank can be provided, which can be filled with the coolant or cooling medium via the supply connection, so that the battery, in particular the outer battery housing, is completely surrounded by this cooling medium, in particular with the exception of possible connection areas. On the other hand, the cooling medium can also be introduced into the interior of the battery housing at the same time, so that the interior of the high voltage battery can also be flooded. The flooding of the interior of the battery housing and of the housing structure which surrounds the battery housing can also be provided via a common supply connection. This supply connection can represent, for example, a connection which is accessible from outside the motor vehicle, to which, for example, a hose, such as a fire hose or any other device, can be connected. In particular, several such supply connections can also be provided on the vehicle. The fire brigade therefore does not have to look for separate connections in order to flood the battery housing on the one hand and to flood the housing structure on the other hand, instead, the hose can simply be connected to the supply connection and the cooling medium, for example water, can be supplied, which by means of the battery arrangement, in particular the flooding device, is guided both into the interior of the battery housing and into the intermediate space outside the battery housing. This maximizes the efficiency of cooling or extinguishing the battery and increases safety enormously.

Furthermore, a motor vehicle with such a battery arrangement or one of its embodiments, which will be explained in more detail below, should also be regarded as belonging to the invention. In particular, all of the motor vehicle components that are still explained within the scope of the invention can be regarded as part of the battery arrangement.

The high voltage battery has several battery cells, as defined above. These battery cells can be formed, for example, as lithium-ion cells. Furthermore, these battery cells can be combined into cell packs and thus form corresponding battery modules. An optional module housing can also be assigned to a respective battery module. In other words, the individual battery cells can be arranged as cell packs in a module housing, which in turn is arranged in the battery housing of the high voltage battery. Precisely in this case, it is preferred that the cooling medium can be supplied to the interior of the battery housing by means of the flooding device so that the cooling medium comes into direct contact with at least one battery cell, in particular its cell poles. Despite the risk of short circuits, it has been shown that this represents the most effective way to prevent or delay thermal propagation or to extinguish a battery fire if it has already started.

The fact that the housing structure encloses the high voltage battery so that an intermediate space which surrounds the battery housing on all sides remains can be understood in such a way that the housing structure forms a housing for the high voltage battery, so to speak, wherein the high voltage battery has a distance from this housing structure on all sides. For example, the high voltage battery, in particular the battery housing, can be formed as a cube and have six sides, namely a top, a bottom, a front, a back, a left side and a right side. This high voltage battery is preferably arranged below a vehicle floor of the motor vehicle. The top then represents the side of the battery housing facing the vehicle floor, the bottom the side facing away from the vehicle floor and facing the ground, the front the side facing a vehicle front, the back or backside the side facing a rear of the vehicle, a left side a driver side and a right side a passenger side. Furthermore, the housing structure can have corresponding six sides which are spaced apart from the sides of the battery housing. In other words, one respective side of the housing structure can be assigned to one side of the battery housing. Some sides of the housing structure or at least parts thereof can also be provided by body parts of the motor vehicle. For example, an upper side of the housing structure can be formed by a vehicle floor.

The battery housing in which the several battery cells are accommodated can represent a module housing of a battery module. Such a battery module can accordingly be provided by the battery housing with the battery cells accommodated therein. The high voltage battery can also have several such battery modules. In this case, the housing structure can represent, for example, an overall battery housing in which the several battery modules are accommodated. Alternatively, however, the battery housing in which the several battery cells are accommodated can be understood as the overall battery housing, in particular in which the battery cells optionally grouped into several battery modules or cell stacks are accommodated. In this case, the housing structure can represent a housing that additionally surrounds the overall battery housing.

The housing structure of the flooding device can be formed at least partially by a body and/or by an attachment part of the motor vehicle. Thus, the housing structure is a part of the body and alternatively or additionally of the attachment part at least in sections. In particular, the housing structure can be completely or at least substantially integrated into the body and/or the attachment part. In the present case, a body is understood to mean a structure of the motor vehicle on a supporting undercarriage (chassis or frame) or the structure and the undercarriage of the motor vehicle. The body can comprise, for example, a sill, which is arranged between a front and a rear wheel housing in the vertical direction of the vehicle below a door entry. Further, the body can comprise a supporting vehicle pillar (for example A pillar, B pillar, C pillar, D pillar) which connects a roof area to a substructure of the body. The attachment part of the motor vehicle can be formed, for example, as a door, an underride guard, a fender, a flap or a hinge that can be firmly integrated into the body. Alternatively or additionally, the attachment part can also be a spoiler, a front or a rear wing. This results in the advantage that the flooding device can be integrated into an existing structure, i.e. the body and alternatively or additionally the attachment part of the motor vehicle and no additional installation space is required for arranging the flooding device inside the motor vehicle.

Furthermore, it is provided according to an advantageous configuration of the invention that cooling medium supplied to the intermediate space and/or the battery housing through the at least one drain means can be guided out of the battery arrangement. This configuration is particularly advantageous because it is based on the finding that the cooling effect can be increased enormously, on the one hand by the fact that the intermediate space can not only be filled with a cooling medium, but can also be flowed through by providing a corresponding drain means, shortly also referred to as drain below, and on the other hand, that thereby defined flow conditions can be adjusted, whereby the cooling medium throughput can be increased and thereby the effectiveness of the cooling can be maximized. By flowing through the intermediate space, significantly more thermal energy can be released from the battery to the cooling medium per unit of time. In addition, the housing structure makes it possible to keep this cooling medium directly on the battery housing over a large area, so that the heat transfer surface is maximized. The drain allows the warm cooling medium to be discharged, while at the same time new and cold cooling medium can be supplied via the supply connection.

In this case, too, it is conceivable that not only one drain means is provided, but several ones. In addition, it is particularly advantageous if, for example, the at least one drain means is set up in such a way that a cooling medium supplied to the drain means can be introduced into the optional intermediate space and/or into the battery housing. For example, the drain means can also provide a supply connection. In other words, such a drain means can also be used as a cooling medium supply means at the same time. Conversely, it can also be provided that cooling medium can be discharged via the at least one supply connection, which can accordingly be regarded as part of a supply means. In other words, the supply and drain means can be constructed in the same way. This has the great advantage that when the fire brigade arrives at the scene of the accident, all they have to do is find or access a supply connection on the vehicle, even if it is assigned to the stated drain means, in order to supply the cooling medium to both the intermediate space and the battery housing. A further supply connection then automatically acts as a drain. It is therefore not necessary to distinguish between supply connections and drain connections, but the fire brigade can simply use the next best connection available on the vehicle in order to supply the coolant as quickly as possible and thus be able to initiate the rescue measures as quickly as possible.

As described above, it is advantageous that the cooling medium can be held on the battery housing by the housing structure, at least temporarily, when the cooling medium flows through the intermediate space. For this purpose, it is furthermore particularly advantageous if the housing structure, at least up to at least one coupling area, is formed to be watertight for the at least one drain means and/or for the at least one supply connection. In other words, although the cooling medium, such as water, can be supplied via the supply connection and discharged via the drain means or vice versa, several such supply connections and drain means can also be provided, which are then connected to the housing structure in corresponding coupling areas, but otherwise no further opening should be provided in the housing structure, from which the cooling medium, such as water, can exit. This is because if the cooling medium were able to leak, the cooling efficiency could be reduced as a result. The tightness of the housing structure can be adjusted, for example, via appropriate seals, screw connections, adhesive bonds or other sealing means. The enclosing housing structure can also have at least one sealed aperture for cable connections and/or battery cooling tubes via which these components are guided into the interior of the battery housing. The watertightness should preferably be designed in such a way that it withstands a pressure which corresponds to the water pressure of a fire hose. This minimizes the cooling water loss and maximizes the cooling efficiency.

In a further advantageous configuration of the invention, the flooding device has a first line from at least one supply connection at least up to the housing structure, via which cooling medium supplied to the at least one supply connection can be supplied to the intermediate space. In other words, the supply connection is fluidically connected to the intermediate space via this first line. This fluidic connection can optionally also be formed to be closed or closable during normal operation of the motor vehicle. In particular, in order to prevent unauthorized supplying of liquids through the supply connection by unauthorized persons, the supply connection and/or this first line and/or the second line described below can also have a protective device to protect against vandalism or misuse. It can be formed, for example, as a pressure relief valve, which releases the fluidic connection between the supply connection and the intermediate space only above a minimum pressure, for example above 12 bar or above 20 bar or generally above a minimum pressure in the range between 10 bar and 25 bar, which is exceeded by the water pressure of a fire hose. Other possibilities for such a protective device can also be a mechanical locking, locks or a specific coupling mechanism which releases the fluidic connection only when a fire hose is coupled according to the key-lock principle. The same can also apply to the at least one drain means. Moreover, the at least one drain means can also have a drain opening, which can be formed exactly like the at least one supply connection, for example, and which can be fluidically connected or connectable at least to the intermediate space and/or the battery housing via a corresponding line. This line can be formed as described for the first line. The line can be provided as a hose or tube, for example. With such a line, it is advantageously possible to provide the supply connection and the opening for the drain means at any point on the motor vehicle, so to speak. In other words, these connections do not have to be provided in close proximity to the housing structure and/or the battery housing, which is nevertheless also possible. Especially when the supply connection is to be provided, for example, in a sill area of the motor vehicle, this first line can also be made very short, since the housing structure and/or the battery housing is then preferably located directly behind this sill area. For example, in this case, the first line and/or the second line described below and the supply connection can be formed as a simple nozzle on the housing structure and/or the battery housing, which is covered from the outside by a cap or the like.

In a further very advantageous configuration of the invention, the flooding device has a second line from at least one supply connection at least to the battery housing, via which cooling medium supplied to the supply connection can be introduced into the battery housing. If a housing structure is provided, this second line can also run through the optional intermediate space. This second line can also be designed, for example, as a pipe or hose or the like. In other words, a first line can optionally open into the intermediate space from the supply connection and a second line can be guided through the optional intermediate space and open into the battery housing or, for example, also into a module housing of a battery module arranged in the battery housing. This second line can also be provided independently of a presence of the first line, and in particular independently of the presence of the housing structure. At least as far as the battery housing, it should therefore be understood that this second line can also lead into the battery housing. Cooling medium supplied to the supply connection can thus be introduced directly into the battery housing through such a second line. This allows flooding with the intermediate space as quickly and simultaneously as possible. For example, the amounts of cooling medium which are to be supplied to the intermediate space and/or the battery housing can also be specifically adjusted via such lines such as the first and the second line. This can be adjusted, for example, by suitable line cross sections. If, for example, the second line has the same line cross section as the first line, the amount of cooling medium supplied to the supply connection is approximately evenly divided between these two lines and, correspondingly, the same amount of cooling medium is supplied to the intermediate space as to the battery housing per unit of time, in particular if the respective processes from the battery housing and the intermediate space are carried out in the same way. For example, if a larger amount of cooling medium should be able to be supplied to the intermediate space per unit of time, the first line cross section can correspondingly be made larger than the second line cross section of the second line. A further advantage of the provision of a second line separate from the first, which opens into the battery housing, also is that the cooling medium is not heated or is hardly heated as it passes through this line until it is introduced into the battery housing.

Again, it also applies here that the drain means can be designed completely analogously. In other words, the drain means can correspondingly also have a first line from a drain opening to the intermediate space, which therefore opens into the housing structure and/or a second line from this opening, which opens into the battery housing. The cooling medium can thus be discharged from the battery housing via the second line and/or the cooling medium can be separately discharged in the intermediate space via the first line.

In a further advantageous configuration of the invention, the battery housing has at least one opening through which cooling medium located in the intermediate space can be guided into the battery housing. In other words, this opening fluidically connects the intermediate space with the interior of the battery. This connection can also be designed to be closable or closed during normal operation, for example, and released automatically or in a controllable manner under certain conditions, for example at a threshold pressure or at a threshold temperature. Such an opening can be designed, for example, with a bursting element, such as a bursting membrane or a pressure relief valve or the like. But the opening can also be present permanently unlocked. In particular, since a housing structure is provided which encloses the battery housing, the battery housing itself does not necessarily have to be formed to be completely closed in order to protect the cells from environmental influences or the like. Here, this protective function can additionally be partially taken over by the housing structure. Via such at least one opening in the battery housing, cooling medium introduced into the intermediate space can now advantageously flow automatically into the interior of the battery housing. It is therefore not necessary to provide an additional extra line from the supply connection into the interior of the battery housing. Nevertheless, the variants described above can also be combined, i.e. in addition to such an opening in the battery housing, a separate line can be provided from the supply connection to the battery housing or into the battery housing.

Furthermore, it is advantageous if at least two such openings are arranged in the battery housing, in particular on opposite sides if possible, so that one of these openings can function as a supply opening and the other one as a discharge opening. As a result, the inside of the battery housing can also be flowed through by the cooling medium in a targeted manner, as a result of which the cooling effect can be increased. Since in this case the cooling medium is first supplied to the intermediate space and only then pushes through such an opening into the interior of the battery housing, it may be that the cooling medium has already warmed up somewhat in the meantime. Nevertheless, this provides a particularly simple and cost-effective configuration of the flooding device, since additional lines can be omitted. The omission of additional lines can also have a positive flow effect on the flow around the battery housing by the cooling medium flowing through the intermediate space.

The second line can be connected to the battery housing in a first coupling area or led into it, and the second line of the drain means can be connected to the battery housing in a second coupling area or led into it. In the simplest case, these coupling areas, which are partly also referred to below as connecting pieces, can be configured as openings in the battery housing. Furthermore, it is advantageous if the first and the second coupling area are arranged on opposite sides of the battery housing if possible. As a result, the inside of the battery housing can also be flowed through by the cooling medium in a targeted manner, as a result of which the cooling effect can be increased.

In a further advantageous configuration of the invention, the flooding device has a pump, by means of which the fluid introduced into the intermediate space can be circulated around the battery housing. In other words, the cooling medium can be circulated, for example, between the drain means and the coupling area of the at least one first line, in particular with the aid of a pump. It can also be arranged in the intermediate space, for example. Furthermore, a cooling device can also be provided, which can additionally cool the circulating cooling medium. For example, the cooling medium can be routed past a heat exchanger. The heat exchanger can, for example, be coupled to a refrigeration circuit of the motor vehicle or the like. This further increases the cooling efficiency.

Furthermore, the invention also relates to a motor vehicle with a battery arrangement according to the invention or one of its configurations. The advantages mentioned for the battery arrangement according to the invention and its configurations thus apply similarly to the motor vehicle according to the invention.

It is also very advantageous if the motor vehicle has a driver door and a passenger door, as well as a first sill area below the driver door and a second sill area below the passenger door. In this case, the at least one supply connection and/or an outlet area of the drain means is preferably arranged in the first sill area and/or in the second sill area. The sill area represents the area in which a side sill of the motor vehicle is arranged. The provision of the at least one first supply connection is particularly advantageous at the position described, since this area is then in the immediate vicinity of the housing structure and/or of the battery housing and is also easily accessible. It is also particularly advantageous if such a supply connection is provided in both sill areas. As explained above, one of them can then also function as a drain accordingly. If one side of the vehicle is inaccessible or difficult to access due to an accident, access is usually all the easier on the opposite side. In this way, the side of the motor vehicle that is more easily accessible can simply be selected in order to connect a fire hose or the like to the supply connection in question, in order to supply the cooling medium to the cooling means in this way. The at least one supply connection is therefore preferably located on the side in the area below the side doors or in the sill area, preferably on both sides of the vehicle, which enables increased accessibility, even if the motor vehicle rolls over. Furthermore, it is preferred that the supply connection is guided completely through the sill profile into the air gap between the sill profile and the battery housing, i.e. into the intermediate space between the housing structure partially provided by the sill profile and the battery housing.

The water outlets, i.e. the drain means, can be embodied in a comparable design, but preferably spatially in relation to at least one predetermined direction, for example in the longitudinal direction of the vehicle, as far away as possible from at least one supply connection or the outlet point at which the first and/or the second line opens into the intermediate space and/or the battery housing, for example on the opposite side of the intermediate space or the battery housing. In a very simple configuration, for example, the supply connection with the first and/or the second line, as well as the at least one drain means can be formed simply as a water filler neck and water outlet neck. These can be arranged in such a way that a design sill cover completely conceals them from the outside of the vehicle, but optionally with easily removable recesses in the trim to enable quick access. This trim or sill cover can, for example, be formed analogously to a towing eyelet cover. In addition, this trim or cover can be designed with an optical feature in order to enable it to be found quickly.

A further advantageous embodiment provides that the first connecting piece and/or the second connecting piece of the flooding device extends through the body and/or through the attachment part to an outside of the motor vehicle in each case via a guide element, namely the lines described above. The outside is a flat outer shell of the motor vehicle, by means of which the motor vehicle adjoins an environment on the outside. Thus, at least one of the two connecting pieces of the flooding device is connected to the outer shell of the motor vehicle via the respective guide element, i.e. the respective line. The respective guide element can be, for example, a fluid-tight pipe or line section that is set up to convey the liquid from the outer shell to the respective one of the connecting pieces in the battery housing and/or into the housing structure and vice versa. The respective guide element can be formed of a plastic or a metal, for example. This results in the advantage that the two connecting pieces are accessible from the surroundings of the motor vehicle by means of the respective guide element. This means that there is no need for a complicated threading in or routing of a supply line through the body and/or the attachment part through to the respective one of the connecting pieces.

A further advantageous embodiment provides, as already mentioned above, for the motor vehicle to have a trim with a first trim element and/or a second trim element. Trim in the sense of the invention is understood to be a flat component (casing) of the motor vehicle, which forms a surface of the motor vehicle. In this case, the trim comprises in particular two trim elements, i.e. the first trim element and the second trim element, wherein the second trim element can be the first trim element or differ from the first trim element. The second trim element has a recess for a removable cover. The cover can be, for example, a movable flap or a removable lid. The recess is an opening or an indentation in the second trim element. The recess of the second trim element can be filled by means of the cover in such a way that a visual identification of the recess is made more difficult or impossible. The first connecting piece and/or the second connecting piece of the flooding device or the at least one supply connection and the at least one drain means are each covered by the first trim element of the trim or the cover. A cover in the sense of the invention is understood to mean that when the motor vehicle is parked as intended on a road surface from an observing position, the first connecting piece and/or the second connecting piece is covered, i.e. invisible. The observation position is at least 0.5 m higher than the road surface in the vertical direction of the vehicle. Thus the first connecting piece and/or the second connecting piece or the at least one supply connection and the at least one drain means are invisible to a person standing on the road surface, i.e. cannot be detected visually. Further, the first connecting piece and/or the second connecting piece or the at least one supply connection and the at least one drain means for a sensor, which is directed to the parked motor vehicle starting from the observing position, are further located outside a direct, i.e. immediate, detection area. This results in the advantage that the first connecting piece and/or the second connecting piece or the at least one supply connection and the at least one drain means are integrated into a design of the motor vehicle in such a way that a visual perception is made more difficult and influencing of a shape of the motor vehicle is limited by at least one of the two connecting pieces.

Optionally, the inlet and outlet connecting pieces or the at least one supply connection and an outlet area of the drain means can also be arranged in the engine compartment, front trunk, underbody, rear end or trunk. In other words, the at least one supply connection and/or an outlet area of the drain means can be arranged in an engine compartment and/or front trunk and/or underbody and/or tail end and/or trunk. For example, the connecting piece of the flooding device arranged on the first coupling area of the battery housing can also be arranged on a first component and the connecting piece of the flooding device arranged on the second coupling area of the battery housing can be arranged on the first component or on a second component or open into them, wherein a component in this context can be understood to mean, for example, the sill, an engine compartment, a front or rear trunk, an underbody or a tail end. Thus, for example, the first connecting piece can be positioned in an area of the engine compartment and the second connecting piece can also be positioned in the area of the engine compartment or in a different area. This results in the advantage that the two connecting pieces can be flexibly arranged inside the motor vehicle for particularly easy accessibility.

When the battery dies down or in the event of thermal runaway, gases are produced which should also be removed in order to rule out the risk of explosion. These gases can, for example, be discharged in a targeted manner via the water inlet or outlet connecting pieces, or generally via the described first and/or second lines, drain means or supply connections that are not currently being used for the supply of the cooling medium, for example on the opposite side of the vehicle. Alternatively, it is also possible to provide additional outgassing outlets, particularly in the battery housing and/or in the housing structure, which are equipped with a pressure relief valve, for example. These outgassing outlets can also be connected to a hose, for example, in order to enable the toxic gases to be discharged in a targeted manner.

To control the state of the battery fire, water inlet and outlet temperature, water mass flows can be measured to detect a possible leakage. Furthermore, gas sensors can also be provided and wet-chemical analysis methods can be provided in order to help with the decision when the high voltage battery has decayed. As a result, a shortening of the decay time or a shortening of the waiting time until the decay occurs can be reached, since the decay can be detected more reliably as a result. Furthermore, it can also be provided that a hose or another discharge device can also be connected to the outlet connecting piece or to the outlet opening of the at least one drain means, so that a targeted discharge of the water or cooling medium into the sewage system or the ditch or a collection container is possible. The outflowing water is usually hot and can sometimes also contain pollutants in the water. This enables a targeted discharge and collection without risks.

The motor vehicle according to the invention is preferably embodied as an automobile, in particular as a passenger car or truck, or as a passenger bus or motorcycle.

Furthermore, the invention also relates to a method for flooding a high voltage battery of a motor vehicle, wherein the high voltage battery has a battery housing and several battery cells in the battery housing, wherein a cooling medium can be introduced into the battery housing via at least one supply connection. The flooding device preferably has at least one drain means through which cooling medium supplied to the battery housing is guided out of the battery arrangement.

The flooding device furthermore optionally comprises a housing structure which encloses the high voltage battery, so that a through-flowable intermediate space which surrounds the battery housing on all sides remains, wherein a cooling medium supplied to at least one supply connection is guided into the intermediate space.

The advantages mentioned for the battery arrangement according to the invention and the motor vehicle according to the invention and its embodiments apply in the same way to the method according to the invention.

The invention also includes further developments of the method according to the invention, which have features as already described in the context of the further developments of the battery arrangement according to the invention and the motor vehicle according to the invention. For this reason, the corresponding further developments of the method according to the invention are not described again here.

The invention also comprises the combinations of the features of the described embodiments. The invention also comprises implementations that each have a combination of the features of several of the described embodiments, unless the embodiments were described as mutually exclusive.

### BRIEF DESCRIPTION OF THE FIGURES

Exemplary embodiments of the invention are described hereinafter. The following is shown:

FIG. 1 shows a schematic representation of a motor vehicle with a battery arrangement and a flooding device according to a first exemplary embodiment of the invention;

FIG. 2 shows a schematic representation of a motor vehicle with a battery arrangement and a flooding device according to a second exemplary embodiment of the invention; and

FIG. 3 shows a schematic and perspective representation of the battery arrangement with a flooding device according to a further exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those represented. Furthermore, the described embodiments can also be supplemented by further ones of the already described features of the invention.

In the figures, same reference numerals respectively designate elements that have the same function.

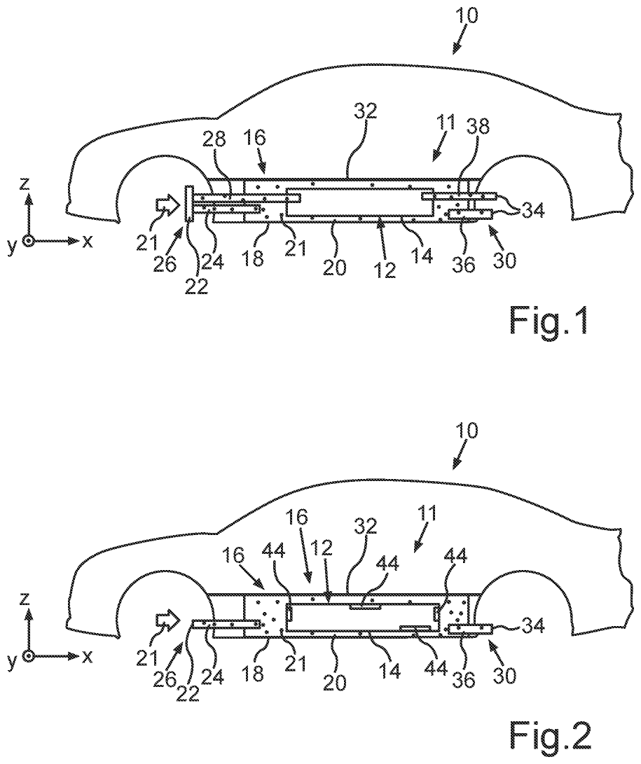

FIG. 1 shows an example of a motor vehicle 10 formed as a passenger car with a battery arrangement 11. The battery arrangement 11 has a high voltage battery 12 which can be formed to supply an electric drive or a hybrid drive of the motor vehicle 10 with electricity. The high voltage battery 12 comprises several battery cells, which are not explicitly represented in this example, and which are accommodated by a battery housing 14. In other words, the battery cells are arranged in the battery housing 14 of the high voltage battery 12. In order to extinguish the high voltage battery 12 particularly efficiently if at least one of the battery cells catches fire, or to delay the burning or even to prevent an overheated battery cell from catching fire, the battery arrangement 11 furthermore has a flooding device 16 which comprises an optional housing structure 18. This housing structure 18 encloses the high voltage battery in such a way that an intermediate space 20 which surrounds the high voltage battery 12 on all sides remains between the housing structure 18 and the battery housing 14, which can also be referred to as an air gap 20, and which can be filled or flowed through by a cooling medium 21. The cooling medium 21 preferably represents a liquid cooling medium, such as water. When water is discussed below as the cooling medium, the exemplary embodiments shown can also be used analogously for other cooling media and extinguishing agents, in particular also gaseous extinguishing agents such as CO₂ or nitrogen.

In order to now supply a cooling medium, such as water, to this intermediate space 20, the flooding device 16 furthermore has at least one supply connection 22. It is fluidically connected to the intermediate space 20. This connection can be provided by a first line 24, for example. The supply connection 22 is furthermore preferably arranged on the outside of the motor vehicle 10 so that it is accessible from outside the motor vehicle, for example for the fire brigade. In order to avoid misuse, a protective measure can also be provided, such as a pressure relief valve, a mechanical lock, locks or the like, so that access to the intermediate space 20 is protected by this protective measure. This applies not only to the supply connection 26, which comprises at least the supply connection 22 and the optional first line 24, as well as a second line 28, which leads from the supply connection 22 into the interior of the battery housing 14, but also analogously to a drain means 30, which will be explained in more detail later.

A cooling medium can therefore be supplied to the intermediate space 20 via the supply connection 26, in particular via the first line 24 mentioned. This line can be formed, for example, as a tube, for example as a connecting piece in the housing structure 18 or a hose or the like that opens into the housing structure 18.

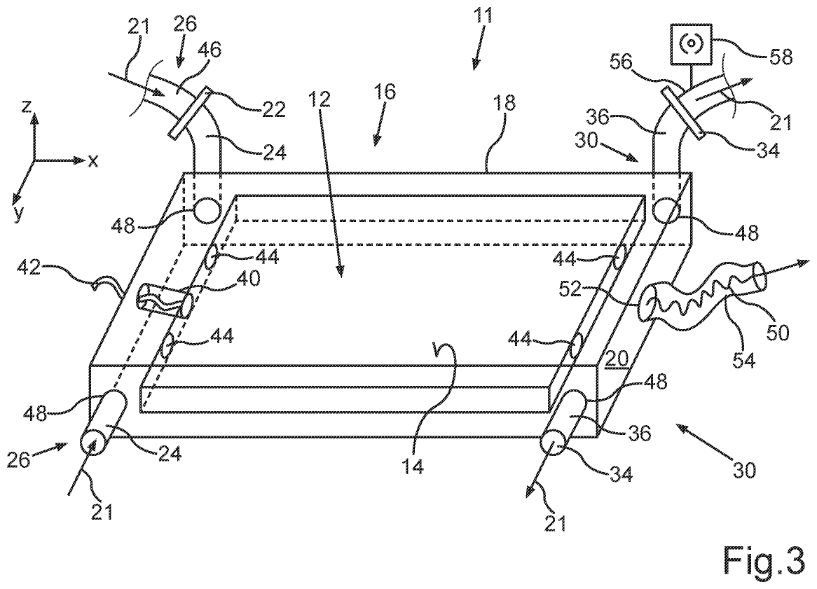

Otherwise, the battery arrangement, and in particular the flooding device with the housing structure, can be formed as in the earlier German patent application by the same applicant entitled “Battery arrangement with flooding device for high voltage battery and motor vehicle and operating method for this” and with the application Ser. No. 10/202,0118892.7, filed on Jul. 16, 2020, in particular except for the possibility provided by the present invention to introduce a cooling medium directly into the battery housing, as is explained in more detail below. Thus, the features and details described for FIG. 1, FIG. 2 and FIG. 3 on pages 17 to 22 of this earlier application and shown in these figures of the earlier application can also be understood as possible further developments of the battery arrangement, the motor vehicle and the method in the context of the present invention. In addition, the features presented in claims 1 to 5 of this earlier application can provide corresponding further developments of the battery arrangement according to the present invention, the features presented in claims 6 to 9 of the earlier application can provide corresponding further developments of the motor vehicle according to the present invention and features presented in claims 10 to 13 of the earlier application 5 can provide corresponding further developments of the method for flooding a high voltage battery according to the present invention.

In this exemplary embodiment, a second line 28 is now also provided, which fluidly connects the same supply connection 22 to an interior of the battery housing 14. This connection can also be secured with one of the protective measures mentioned above. Cooling medium, which is supplied to the supply connection 22, can now advantageously also be introduced via this second line 28 directly into the interior of the battery 12, in particular into the interior of the battery housing 14, in particular in such a way that it can be brought into direct contact with the battery cells including their interconnections. As a result, the extinguishing and cooling effect can be maximized and the process of thermal runaway of the battery cells can be interrupted or at least slowed down in a particularly efficient manner.

The supply connection 22 and/the an opening 34 of the drain means 30 is preferably located laterally in an area of the motor vehicle 10 below the vehicle door, in particular on both sides of the motor vehicle 10, in order to increase accessibility, for example when the motor vehicle 10 rolls over. Optionally, the supply connection 22 and/or the opening 34 of the drain means 30 can also be arranged in an engine compartment, a front trunk, an underbody, a rear closure or a trunk.

These two lines 24, 28 are coupled to the same supply connection 26, which thus provides a main connection. Thus, the great advantage is that the fire brigade only has to operate one main extinguishing connection, namely the supply connection 26, in order to carry out the two important extinguishing and cooling functions at the same time, in particular in the event of a battery fire, namely effective extinguishing of the high voltage battery 12 by introducing water into the high voltage battery 12, and at the same time the flushing of the high voltage battery 12, in particular to cool the vehicle underbody 32, under which the high voltage battery 12 is arranged, in order to delay a fire, for example in the carpeted floor in the vehicle interior, as much as possible.

The flushing of the high voltage battery 12 can be designed particularly advantageously by the housing structure 18, because this allows the individual sides of the battery housing to be cooled particularly efficiently by large-area contact with the cooling medium 21 and not only temporarily and incompletely by spraying or the like. The housing structure 18 thus forms, so to speak, a through-flowable dip tank for the battery 12. As a result, the heat generated in the battery 12 can be dissipated in all directions and the cooling capacity can thereby be maximized.

So that this intermediate space 20 can not only be filled with the cooling medium 21, but can also be flowed through, at least one additional drain means 30 is preferably provided, which allows the cooling medium 21 to be discharged at least from the high voltage battery 12 or the battery housing, and in particular from the intermediate space 20. For this purpose, the drain means 30 can have a drain opening 34 which is fluidically connected to the intermediate space 20 via a line 36. This line 36 can also be protected against misuse by one of the protective measures mentioned above and can be formed to be temporarily lockable, for example. Furthermore, the drain means 30 can also have a further drain line 38 which also fluidly connects an outlet opening 34 to the interior of the battery housing 14. Likewise, this line 38 can be formed to be protected against misuse with one of the protective measures described. Although the two openings 34 of the drain means 30 are represented separately in FIG. 1, they can also open into a common opening 34. In particular, a connection means can also be formed at these openings 34 analogously to the supply connection 22. In other words, the supply means 26 and the drain means 30 can be arranged with the same construction only at different positions of the housing structure 18 and the battery housing 14. These two means, i.e. the supply means 26 and the drain means 30, are preferably located as far away from one another as possible with respect to at least a first direction which can represent, for example, the longitudinal direction of the vehicle or the transverse direction of the vehicle. This allows the flow conditions to be optimized. At the same time, it is preferred that the drain means 30 can also be used as a supply means 26 and vice versa. In other words, the cooling medium 21 can be supplied via the drain means 30 both to the intermediate space 20 and to the interior of the battery housing 14, and conversely this cooling medium 21 can be discharged from the interior of the battery housing 14 and the intermediate space 20 via the supply means 26. If only one of these two means is accessible in the event of an accident of the motor vehicle 10, then the most easily accessible connection can be used to flood battery 12 on the outside and inside. In addition, it is also conceivable to provide additional supply means 26 and drain means 30. Through the targeted discharge of the cooling medium from the housing structure 18 and from the battery 12, a defined flow of extinguishing medium can be provided in the high voltage battery 12 and in the enclosing housing structure 18, as a result of which heat can be dissipated more efficiently. A fire hose, for example, can be connected to at least one main water filler connecting piece, such as the supply connection 22, so that the HV battery 12 can be flushed directly with extinguishing water and flushed directly into the HV battery 12. The water then leaves the enclosing housing structure 18 and the high voltage battery 12 at at least one outlet connecting piece, generally the drain means 30.

A hose or a discharge device can also be connected to the openings 34, which can be provided by outlet connecting pieces, so that the water can be discharged in a targeted manner, for example into the sewage system or a ditch or a collection container, which is particularly advantageous when the water is very hot and partly contains pollutants. Furthermore, it is also conceivable that the water or, in general, the cooling medium 21 can be circulated between the water outlet connecting piece 34 and the water inlet connecting piece 24, possibly with a pumping and cooling means that is not represented in detail in this example.

Furthermore, it is preferred that the enclosing housing structure 18 is designed to be watertight, at least to a pressure which corresponds to the water pressure of a fire hose. The tightness of the enclosing housing structure 18 is adjusted via seals, screw connections, adhesive bonds or other sealing means.

The enclosing housing structure 18 can also have at least one sealed aperture 40 (cf. FIG. 3) for cable connections or battery cooling tubes and so on. In other words, electrical cables 42 (also compare FIG. 3) can be routed through this aperture 40 to the high voltage battery 12 or into its housing 14, as well as other components, such as cooling pipes or hoses, in order to provide battery cooling during normal operation.

FIG. 2 shows a schematic representation of a motor vehicle 10 with a battery arrangement 11 and a flooding device 16 according to a further exemplary embodiment of the invention. In particular, the flooding device 16 can be formed as shown in FIG. 1, apart from the differences described below. In this example, the supply means 26 now has no second line 28 that leads from the supply connection 22 directly into the interior of the battery housing 14. Instead, the battery housing 14 itself has openings 44 through which the cooling medium 21, which was guided into the intermediate space 20 via the supply connection 22, can penetrate into the interior of the battery housing 14. These openings 44 can be designed as permanent openings in the battery housing 14 or as openings that can be opened, for example openings that can be opened under a certain minimum pressure or openings that can be opened at a certain minimum temperature. In principle, these openings 44 can be provided on any side of the battery housing 14. The battery housing 14 has at least one such opening 44, preferably at least two, which in turn are particularly preferably arranged as far apart as possible, so that the cooling medium 21 ideally flows through one of the two openings 44 into the battery housing 14, flows through it and can exit again through the other opening 44. Correspondingly, it is also advantageous if one of the openings 44 is arranged in the area of the supply means 26 and the other one of the two openings 44 in the area of the drain means 30, since in this way specifically defined flow conditions can be set. In principle, however, openings 44 at other points of the battery housing 14 are also conceivable. The cooling medium 21, for example water, can thus in turn be supplied to the intermediate space 20 via the supply connection 22. For this purpose, a fire hose, for example, can in turn be connected to the supply connection 22. In order to reversibly and detachably connect the supply connection 22 to such a liquid-carrying line 46 as the fire hose 46, the supply connection 22, as well as the opening 34 of the drain means 30, can have a coupling unit. By means of the coupling unit, a fire hose can be connected to the flooding device 16, for example, so that the liquid (extinguishing water) can be flushed directly around the high voltage battery 12. The respective coupling unit can couple the respective connecting piece or the supply connection 22 and/or the opening 34 to the line 46, for example by means of a bayonet lock principle. The respective coupling unit can in particular be formed as a cleat coupling (for example a Storz coupling). A connection made by means of the respective coupling unit can be reversibly released so that the connection can be made non-destructively and released again if necessary. The liquid-carrying line 46 can be, for example, a fire hose 46, by means of which the liquid can be conveyed over a distance. This results in the advantage that a robust connection between the flooding device 1646 and the liquid-carrying line 46 can be provided in a particularly simple manner by means of the respective coupling unit.

The cooling medium 21 introduced into the optional intermediate space 20 continues to penetrate the battery housing 14 via the openings 44 and then comes into direct contact with the battery cells arranged in the battery housing 14, such as lithium-ion cells. If the battery housing 14 is completely flooded, the cooling medium 21 inevitably emerges from further openings 44 depending on the pressure conditions occurring in the housing structure 18 and also leaves the intermediate space 20 again via the drain means 30. This drain means 30 changes to an opening 34 leading to the outside of the motor vehicle.

In this example, too, the relevant openings 22, 34 can again be designed to be covered by appropriate covers or trims, and in addition these accesses can in turn have protection against unauthorized persons and against misuse. This configuration also brings the great advantage that the fire brigade only has to operate one main extinguishing connection, namely the supply connection 22 or optionally also the drain connection 34, in order to simultaneously carry out the two important extinguishing and cooling functions, namely an effective extinguishing of the high voltage battery 12 via the openings in the battery housing 14 by introducing water into the high voltage battery 12 and at the same time flushing the high voltage battery 12 in order to in particular cool the vehicle underbody 32 in turn, and to delay a fire, for example in the carpeted floor in the vehicle interior, as much as possible.

As already described, the openings 44 are preferably arranged spatially close to the supply line 24, so that the extinguishing medium 21 is conveyed into the battery housing 14 with the appropriate water pressure. The introduced water can be drained out again in a targeted manner via at least one water outlet. Thereby, a defined extinguishing medium flow in the high voltage battery 12 and in the enclosing housing structure 18 is possible.

FIG. 3 shows the battery arrangement 11 and in particular the flooding device 16 according to FIG. 2 again in a perspective representation and in particular with minor modifications relating to the position of the openings 44. Other means are also illustrated here, which will now be explained in more detail below. Here, for example, the sealed aperture 40 can be seen in order to guide electrical cables 42 and other components into the interior of the battery housing 14 without contact with the cooling medium 21. Furthermore, FIG. 3 also shows a hose 46, such as a fire hose 46, which is coupled to the supply connection 22 and via which cooling medium 21, which is illustrated here as an arrow, is supplied to the intermediate space 20. As described, the supply connection 22 is coupled to the housing structure 18 via the first line 24 or opens into it. The opening area is labeled 48 here and represents a coupling area. The areas in which the lines 36 of the drain means 30 are connected to the housing structure 18 are also denoted by 48 and also represent coupling areas. During the battery decay process, gases 50 are produced which should be discharged in order to rule out the risk of explosion. For this purpose, an outgassing outlet 52 is considered in the present example, which can be equipped with a pressure relief valve and via which gases 50 can be led out of the housing structure 18 with a corresponding overpressure. Corresponding outgassing outlets can also be provided in the battery housing 14, although they are not explicitly represented here. In the present case, this outgassing outlet 52 is additionally coupled to a hose 54 which is connected in particular to this outlet 52. The gases can be discharged in a targeted manner through such a hose 54, which is particularly advantageous since these can contain toxic substances. Thus, these gases 50 can be routed far away from rescue personnel while they are engaged in occupant rescue and battery extinguishing.

In this example, a hose 56 is also connected to the connection 34 of the drain means 30. The cooling medium 21 can be discharged in a defined manner from the intermediate space 20 via this hose 56 and, for example, guided into a container or ditch or the like. In addition, a sensor means 58 is provided in this example, which is coupled to the hose 56 or can be brought into contact with the discharged cooling medium 21 in order to be able to carry out various measurements, on the basis of which the decay time of the thermal event of the battery 12 can be determined. Such a sensor means 58 can thus be used, for example, to determine the water inlet and outlet temperature and the water flow rate in order to determine a possible leak. The sensor means 58 can also comprise gas sensors or be formed to carry out wet-chemical analysis methods, for example determining the pH value. Furthermore, such a sensor means 58 can be provided at each inlet and outlet, in particular in the lines 24, 36 themselves or in the hoses 46, 56 connected thereto. The state of the battery fire can thereby be advantageously monitored.

Overall, the examples show how the invention can provide a battery extinguishing method through battery openings and with maximized occupant protection, which makes it possible to extinguish the battery particularly efficiently in the event of an overheated battery or a battery fire. The big advantage is that the fire brigade only has to operate one main extinguishing connection in order to simultaneously carry out two important functions in the event of a battery fire, namely effectively extinguishing the high voltage battery by introducing water and flushing the high voltage battery, above all to cool the vehicle underbody. A separate extinguishing lance is not necessary, which means that no special equipment is required and no separate training either. This means that every fire brigade worldwide can control a battery fire. In order to stop or delay a battery fire in a vehicle, it is no longer necessary to completely flood the entire vehicle in a container. People who are trapped can be cut out of the vehicle for a longer period of time, even if the battery is already catching fire. This is possible by flooding the battery in the new enclosing housing structure. Significantly faster decay of the battery compared to conventional measures is also possible. There is no loss of time to get the container, the water volume or the fire-fighting vehicles with a crane. The vehicles no longer have to remain inside the water container for days, since it cannot be detected with certainty whether the battery has already decayed, because during this decay time there is still an abstract safety risk, which means that the decay process must be accompanied in the presence of the fire brigade. The decay times can be significantly reduced by effective cooling, as is made possible by the invention.

1-10. (canceled)

11. A battery arrangement for a motor vehicle, wherein the battery arrangement has a high voltage battery which has a battery housing and several battery cells in the battery housing, and a flooding device for flooding the high voltage battery, wherein the flooding device has at least one supply connection, wherein the battery arrangement is formed to introduce a cooling medium supplied to the at least one supply connection into the battery housing, wherein the flooding device has at least one drain through which cooling medium supplied to the battery housing can be guided out of the battery arrangement.

12. The battery arrangement according to claim 11, wherein the flooding device comprises a housing structure which encloses the high voltage battery so that a through-flowable intermediate space which surrounds the battery housing on all sides remains, wherein the flooding device is formed to supply a cooling medium supplied to the at least one supply connection to the intermediate space, wherein in particular cooling medium supplied to the intermediate space and/or the battery housing can be guided out of the battery arrangement through the at least one drain.

13. The battery arrangement according to claim 11, wherein the cooling medium can be supplied to the interior of the battery housing by the flooding device in such a way that the cooling medium comes into direct contact with at least one battery cell, in particular its cell poles.

14. The battery arrangement according to claim 12, wherein the flooding device has a first line from at least one supply connection at least to the housing structure, via which cooling medium supplied to the at least one supply connection can be supplied to the intermediate space.

15. The battery arrangement according to claim 11, wherein the flooding device has a second line from at least one supply connection at least to the battery housing, via which cooling medium supplied to the at least one supply connection can be introduced into the battery housing.

16. The battery arrangement according to claim 12, wherein the battery housing has at least one opening through which cooling medium located in the intermediate space can be guided into the battery housing.

17. A motor vehicle with a battery arrangement according to claim 11.

18. The motor vehicle according to claim 17, wherein the motor vehicle has a driver door and a passenger door, as well as a first sill area below the driver door and a second sill area below the passenger door, wherein the at least one supply connection and/or an outlet area of the drain is arranged in the first sill area and/or the second sill area.

19. The motor vehicle according to claim 17, wherein the at least one supply connection and/or an outlet area of the drain is arranged in an engine compartment and/or front trunk and/or underbody and/or tail end and/or trunk.

20. A method for flooding a high voltage battery of a motor vehicle, wherein the high voltage battery has a battery housing and several battery cells in the battery housing, wherein a cooling medium can be introduced into the battery housing via at least one supply connection, wherein the flooding device has at least one drain through which cooling medium supplied to the battery housing is guided out of the battery arrangement.

21. The battery arrangement according to claim 11, wherein the cooling medium can be supplied to the interior of the battery housing by the flooding device in such a way that the cooling medium comes into direct contact with at least one battery cell, in particular its cell poles.

22. The battery arrangement according to claim 12, wherein the flooding device has a first line from at least one supply connection at least to the housing structure, via which cooling medium supplied to the at least one supply connection can be supplied to the intermediate space.

23. The battery arrangement according to claim 12, wherein the flooding device has a second line from at least one supply connection at least to the battery housing, via which cooling medium supplied to the at least one supply connection can be introduced into the battery housing.

24. The battery arrangement according to claim 13, wherein the flooding device has a second line from at least one supply connection at least to the battery housing, via which cooling medium supplied to the at least one supply connection can be introduced into the battery housing.

25. The battery arrangement according to claim 14, wherein the flooding device has a second line from at least one supply connection at least to the battery housing, via which cooling medium supplied to the at least one supply connection can be introduced into the battery housing.

26. The battery arrangement according to claim 22, wherein the flooding device has a second line from at least one supply connection at least to the battery housing, via which cooling medium supplied to the at least one supply connection can be introduced into the battery housing.

27. The battery arrangement according to claim 13, wherein the battery housing has at least one opening through which cooling medium located in the intermediate space can be guided into the battery housing.

28. The battery arrangement according to claim 14, wherein the battery housing has at least one opening through which cooling medium located in the intermediate space can be guided into the battery housing.

29. The battery arrangement according to claim 15, wherein the battery housing has at least one opening through which cooling medium located in the intermediate space can be guided into the battery housing.

30. The motor vehicle according to claim 18, wherein the at least one supply connection and/or an outlet area of the drain is arranged in an engine compartment and/or front trunk and/or underbody and/or tail end and/or trunk.
